(19) United States
(12) Patent Application Publication
(10) Pub. No.: US 2012/0102066 A1
(43) Pub. Date: Apr. 26, 2012

(54) Method, Devices and a Service for Searching

(75) Inventors: Antti Eronen, Tampere (FI); Miska Hannuksela, Ruutana (FI); Pasi Ojala, Kirkkonummi (FI); Jussi Leppanen, Tampere (FI); Kalervo Kontola, Tampere (FI)

(73) Assignee: NOKIA CORPORATION, Espoo (FI)

(21) Appl. No.: 13/380,509

(22) PCT Filed: Jun. 30, 2009
(86) PCT No.: PCT/FI2009/050589

§ 371 Date: Dec. 22, 2011

(51) Int. Cl. G06F 17/30

(52) U.S. Cl. 707/769; 707/E17.014; 707/E17.023

(57) ABSTRACT

A method, devices and an internet service is disclosed for carrying out an improved search. Audio features formed from audio data are associated with the image data. The audio features are formed by applying a transform to the audio data, for example to form mel-frequency cepstral coefficients from the audio data. A search criterion for the audio features is specified in addition to a search criterion for the image data. A search is carried out to find image data, and the search criterion for the audio features is used in the search.

### FIELD OF THE INVENTION

The present invention relates to searching for data, especially for image data.

### BACKGROUND

Digital cameras have become a common household object very quickly in the past decade. In addition to standalone cameras, many other electronic devices like mobile phones and computers are being equipped with a digital camera. The pictures taken with a digital camera are saved on a memory card or internal memory of the device, and they can be accessed for viewing and printing from that memory easily and instantaneously. Taking a photograph has become easy and very affordable. This has naturally led to an explosion in the number of digital pictures and with a usual size of a few megabytes per picture, to an explosion of the storage needs. To manage the thousands of pictures a person easily has, computer programs and internet services have been developed. Such programs and services typically have features that allow a person to arrange the pictures according to some criteria, or even carry out a search to find the desired images.

In addition to digital photographs the digital cameras usually allow for the capture of digital video, as well. Digital video is a sequence of coded pictures that is usually accompanied with an audio track for the related sound. Whereas a single digital picture can take up to a few megabytes to store, a video clip easily spans hundreds of megabytes even with advanced compression. To manage the personal digital videos, computer programs and internet services have again been developed. These programs and services typically have features that allow for browsing of different video clips and also enable viewing the contents of the clips.

Searching for pictures and videos containing desired content is a challenging task. Often, some additional information on the picture or video like the time or the place of capture is available to help in the search. It is also possible to analyze the picture contents e.g. by means of face recognition so that people's names can be used in the search. This naturally requires some user interaction to associate the names to the faces recognized. To help the search, users of the picture and video management systems may give textual input to be attached to the pictures, they may classify and rate pictures and perform other manual tasks to help in identifying desired pictures later when they need to find them. Such manual operations are clumsy and time-consuming, and on the other hand, fully automatic picture search methods may often yield unsatisfactory results.

There is, therefore, a need for a solution that improves the reliability and usability of picture and video searching.

### Some Example Embodiments

Now there has been invented an improved method and technical equipment implementing the method, by which the above problems are alleviated. Various aspects of the invention include a method, an apparatus, a server, a client and a computer readable medium comprising a computer program stored therein, which are characterized by what is stated in the independent claims. Various embodiments of the invention are disclosed in the dependent claims.

According to a first aspect, there is provided a method for carrying out a search with an apparatus, where image data are formed, audio features are formed, the audio features having been created from audio data by feature analysis, the audio features are associated with the image data, and a search is carried out from the image data using the audio features to form image search results.

According to an embodiment, audio data are formed in the memory of the apparatus and the audio data are analyzed to create audio features. According to an embodiment, a first criterion for performing a search among the image data is received, a second criterion for performing a search among the audio features is received and the search is carried out using the first criterion and the second criterion to form image search results. According to an embodiment, the search is carried out by comparing the audio features of the data among which the search is carried out with a second set of audio features associated with image data defined by a user. According to an embodiment, the audio features have been created by applying at least one transform from time domain to frequency domain to the audio data.

According to a second aspect, there is provided an apparatus for carrying out a search comprising a processor, memory including computer program code, and the memory and the computer program code are configured to, with the processor, cause the apparatus to form image data in the memory of the apparatus, to form audio features in the memory of the apparatus, the audio features having been created from audio data by feature analysis, to associate the audio features with the image data, and to carry out a search from the image data using the audio features to form image search results.

According to an embodiment, the apparatus further comprises computer program code that is configured to, with the processor, cause the apparatus to form audio data in the memory of the apparatus and to analyze the audio data to create audio features. According to an embodiment, the apparatus further comprises computer program code that is configured to, with the processor, cause the apparatus to receive a first criterion for performing a search among the image data, to receive a second criterion for performing a search among the audio features, and to carry out the search using the first criterion and the second criterion to form image search results. According to an embodiment, the apparatus further comprises computer program code that is configured to, with the processor, cause the apparatus to carry out the search by comparing the audio features of the data among which the search is carried out with a second set of audio features associated with image data defined by a user. According to an embodiment, the audio features have been created by applying at least one transform from time domain to frequency domain to the audio data. According to an embodiment, the apparatus further comprises computer program code that is configured to, with the processor, cause the apparatus to create the audio features by extracting mel-frequency cepstral coefficients from the audio data. According to an embodiment, the audio features are indicative of the direction of the source of an audio signal in the audio data in relation to the direction of an image signal in the image data. According to an embodiment, the apparatus further comprises computer program code that is configured to, with the processor, cause the apparatus to analyze the audio data to create audio features by applying at least one of the group of audio-based context recognition, speech recognition, speaker recognition, speech/music discrimination, determining the number of audio objects, determining the direction of audio objects, and speaker gender determination.

According to a third aspect of the invention, there is provided a method for carrying out a search with an apparatus, wherein a first search criterion is formed for carrying out a search among image data, a second search criterion is formed for carrying out a search among audio features created from audio data associated with the image data, and a search is carried out to form image search results by using the first search criterion and the second search criterion.

According to an embodiment, the second search criterion is formed by defining a set of audio features associated with image data to be used in the search. According to an embodiment, data is captured with the apparatus to form at least a part of the image data, data is captured with the apparatus to form at least part of the audio data, and the at least part of the audio data is associated with the at least part of the image data. According to an embodiment, at least part of the audio features is created by applying at least one transform from time domain to frequency domain to the audio data. According to an embodiment, the audio features are mel-frequency cepstral coefficients.

According to a fourth aspect of the invention, there is provided an apparatus comprising a processor, memory including computer program code, the memory and the computer program code configured to, with the processor, cause the apparatus to form a first search criterion for carrying out a search among image data, to form a second search criterion for carrying out a search among audio features created from audio data associated with the image data, and to carry out a search to form image search results by using the first search criterion and the second search criterion.

According to an embodiment, the apparatus further comprises computer program code that is configured to, with the processor, cause the apparatus to form the second search criterion by defining a set of audio features associated with image data to be used in the search. According to an embodiment, the apparatus further comprises computer program code that is configured to, with the processor, cause the apparatus to capture data with the apparatus to form at least a part of the image data, to capture data with the apparatus to form at least part of the audio data, and to associate the at least part of the audio data with the at least part of the image data. According to an embodiment, the apparatus further comprises computer program code that is configured to, with the processor, cause the apparatus to create at least part of the audio features by applying at least one transform from time domain to frequency domain to the audio data. According to an embodiment, the apparatus further comprises computer program code configured to, with the processor, cause the apparatus to create at least part of the audio features by extracting mel-frequency cepstral coefficients from the audio data.

According to a fifth aspect, there is provided a computer program product stored on a computer readable medium and executable in a data processing device, wherein the computer program product comprises a computer program code section for forming image data in the memory of the apparatus, a computer program code section for forming audio features in the memory of the apparatus, the audio features having been created from audio data by feature analysis, a computer program code section for associating the audio features with the image data, and a computer program code section for carrying out a search from the image data using the audio features to form image search results.

According to a sixth aspect, there is provided a computer program product stored on a computer readable medium and executable in a data processing device, wherein the computer program product comprises a computer program code section for forming a first search criterion for carrying out a search among image data, a computer program code section for forming a second search criterion for carrying out a search among audio features created from audio data associated with the image data, and a computer program code section for carrying out a search to form image search results by using the first search criterion and the second search criterion.

According to a seventh aspect, there is provided a method comprising facilitating access, including granting access rights to allow access, to an interface to allow access to a service via a network, the service comprising electronically generating a first search criterion for carrying out a search among image data, electronically generating a second search criterion for carrying out a search among audio features created from audio data associated with the image data, and electronically carrying out a search to generate image search results by using the first search criterion and the second search criterion.

According to an eighth aspect, there is provided a computer program product stored on a computer readable medium and executable in a data processing device, wherein the computer program product comprises a computer program code section for forming image data in a memory of the device, a computer program code section for forming audio features in a memory of the device, the audio features having been created from audio data by feature analysis, a computer program code section for associating the audio features with the image data, and a computer program code section for carrying out a search from the image data using the audio features to form image search results.

According to a ninth aspect, there is provided a computer program product stored on a computer readable medium and executable in a data processing device, wherein the computer program product comprises a computer program code section for forming a first search criterion for carrying out a search among image data, a computer program code section for forming a second search criterion for carrying out a search among audio features created from audio data associated with the image data, and a computer program code section for carrying out a search to form image search results by using the first search criterion and the second search criterion.

According to a tenth aspect, there is provided an apparatus comprising means for forming image data in the memory of the apparatus, means for forming audio features in the memory of the apparatus, the audio features having been created from audio data by feature analysis, means for associating the audio features with the image data, and means for carrying out a search from the image data using the audio features to form image search results.

According to an eleventh aspect, there is provided an apparatus comprising means for forming a first search criterion for carrying out a search among image data, means for forming a second search criterion for carrying out a search among audio features created from audio data associated with the image data, and means for carrying out a search to form image search results by using the first search criterion and the second search criterion.

According to a twelfth aspect, there is provided an apparatus, the apparatus being a mobile phone and further comprising user interface circuitry for receiving user input, user interface software configured to facilitate user control of at least some functions of the mobile phone through use of a display and configured to respond to user inputs, and a display and display circuitry configured to display at least a portion of a user interface of the mobile phone, the display and display circuitry configured to facilitate user control of at least some functions of the mobile phone, the apparatus further comprising a processor, memory including computer program code, the memory and the computer program code configured to, with the processor, cause the apparatus to form a first search criterion for carrying out a search among image data, to form a second search criterion for carrying out a search among audio features created from audio data associated with the image data, and to carry out a search to form image search results by using the first search criterion and the second search criterion.

According to a thirteeth aspect, there is provided a system comprising at least one processor, memory including computer program code, the memory and the computer program code configured to, with the at least one processor, cause the system to form a first search criterion for carrying out a search among image data, to form a second search criterion for carrying out a search among audio features created from audio data associated with the image data, to carry out a search to form image search results by using the first search criterion and the second search criterion, to capture data to form at least a part of the image data, to capture data to form at least part of the audio data, and to associate the at least part of the audio data with the at least part of the image data.

### DESCRIPTION OF THE DRAWINGS

In the following, various embodiments of the invention will be described in more detail with reference to the appended drawings, in which

FIG. 1 shows a method for carrying out a search to find image data;

FIG. 2a shows devices, networks and connections for carrying out a search in image data;

FIG. 2b shows structure of devices for forming image data, audio data and search criteria for carrying out an image search.

FIG. 3 shows a method for carrying out a search from image data by applying a search criterion on audio features;

FIG. 4 shows a method for carrying out a search from image data by comparing audio features associated with images;

FIG. 5 shows a diagram of the formation of audio features by applying a transform from time-domain to frequency domain;

FIG. 6a shows a diagram of the formation of mel-frequency cepstral coefficients as audio features;

FIG. 6b shows a possible formation of a filter bank for the creation of mel-frequency cepstral coefficients or other audio features.

FIG. 7a/7b show the capture of audio signal where the source of the audio signal is positioned in a certain direction relative to the receiver and the camera

### DESCRIPTION OF EXAMPLE EMBODIMENTS

In the following, several embodiments of the invention will be described in the context of searching for image data from a device or from a network service. It is to be noted, however, that the invention is not limited to searching of image data, a specific device or a specific network setup. In fact, the different embodiments have applications widely in any environment where searching of media data needs to be improved.

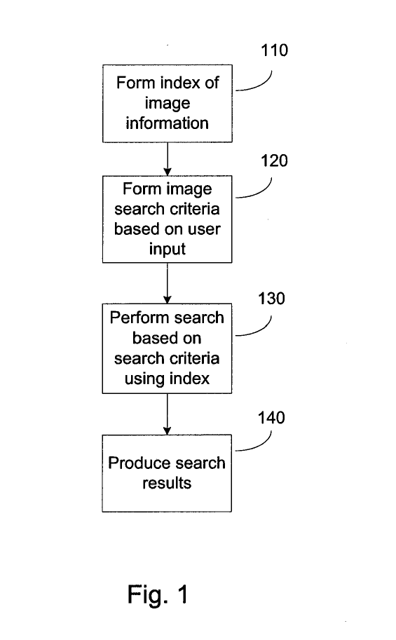

FIG. 1 shows one method for carrying out a search to find image data. Before a search is carried out, it may be useful to build an index of the characteristics in the image data among which the search is carried out, as is done in step 110. Forming the index may be done off-line before the search because building an index may be time-consuming. The image data characteristics may be color histogram information or other color information of the image, shape information, pattern recognition information, image metadata such as time and date of capture, location, camera settings etc. It needs to be noted that the image data to be indexed may be but need not be located at the same device or computer than where the index is built—in fact, the images can reside anywhere where the computer doing indexing has access to, e.g. on different internet sites or network storage devices. Image data may be still image pictures, pictures of a video sequence, or any other form of visual data.

In step 120, search criteria for performing the image search may be formed. This may be done by requesting input from the user, e.g. by receiving text input from the user. Query-by-example methods for images often yield good results, too. In a query-by-example method, the user chooses an image he would like to use in the search so that similar images to the one specified are located. Other ways of identifying image features like giving names of persons, locations or times can be used for forming the search criteria.

In step 130, the search of image data may be carried out. The search may be carried out using the index, if such was built and the data in the index is current. Alternatively, for example in the case where all the image data is locally accessible, the search may be carried out directly from the image data. In the search, the search criteria may be compared against the image characteristics in the index or formed directly using the images. When the search has been carried out, the search results may be produced in step 140. This can happen by displaying the images, producing links to the images, or sending data on the images to the user.

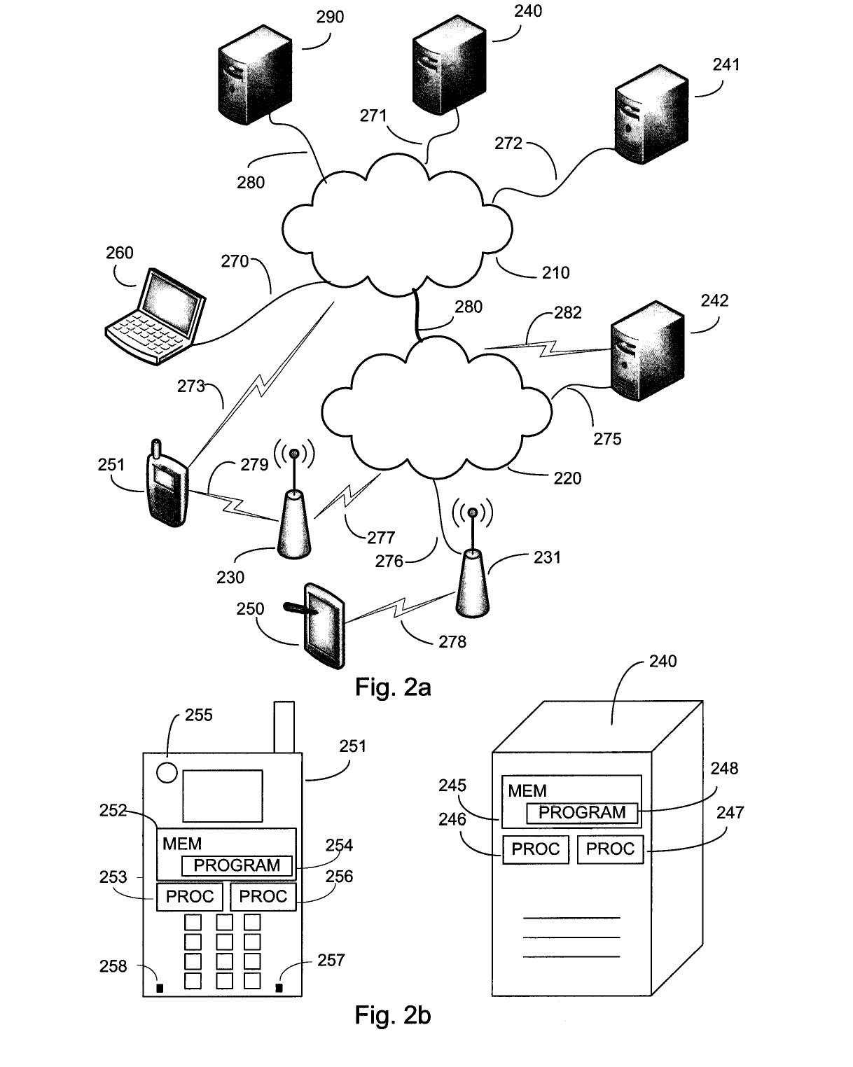

FIG. 2a displays a setup of devices, servers and networks that contain elements for performing a search in data residing on one or more devices. The different devices are connected via a fixed network 210 such as the internet or a local area network, or a mobile communication network 220 such as the Global System for Mobile communications (GSM) network, 3^{rd} Generation (3G) network, 3.5^{th} Generation (3.5G) network, 4^{th} Generation (4G) network, Wireless Local Area Network (WLAN), Bluetooth, or other contemporary and future networks. The different networks are connected to each other by means of a communication interface 280. The networks comprise network elements such as routers and switches to handle data (not shown), and communication interfaces such as the base stations 230 and 231 in order for providing access for the different devices to the network, and the base stations are themselves connected to the mobile network via a fixed connection 276 or a wireless connection 277.

There are a number of servers connected to the network, and here are shown a server 240 for performing a search and connected to the fixed network 210, a server 241 for storing image data and connected to either the fixed network 210 or the mobile network 220 and a server 242 for performing a search and connected to the mobile network 220. There are also a number of computing devices 290 connected to the networks 210 and/or 220 that are there for storing data and providing access to the data via e.g. a web server interface or data storage interface or such. These devices are e.g. the computers 290 that make up the internet with the communication elements residing in 210.

There are also a number of end-user devices such as mobile phones and smartphones 251, internet access devices (internet tablets) 250 and personal computers 260 of various sizes and formats. These devices 250, 251 and 260 can also be made of multiple parts. The various devices are connected to the networks 210 and 220 via communication connections such as a fixed connection 270, 271, 272 and 280 to the internet, a wireless connection 273 to the internet, a fixed connection 275 to the mobile network, and a wireless connection 278, 279 and 282 to the mobile network. The connections 271-282 are implemented by means of communication interfaces at the respective ends of the communication connection.

As shown in FIG. 2b, the search server 240 contains memory 245, one or more processors 246, 247, and computer program code 248 residing in the memory 245 for implementing the search functionality. The different servers 241, 242, 290 contain at least these same elements for employing functionality relevant to each server. Similarly, the end-user device 251 contains memory 252, at least one processor 253 and 256, and computer program code 254 residing in the memory 252 for implementing the search functionality. The end-user device may also have at least one camera 255 enabling the tracking of the user. The end-user device may also contain one, two or more microphones 257 and 258 for capturing sound, arranged as a single microphone, a stereo microphone or a microphone array, any combination of these, or any other arrangement. The different end-user devices 250, 260 contain at least these same elements for employing functionality relevant to each device. Some end-user devices may be equipped with a digital camera enabling taking digital pictures, and one or more microphones enabling audio recording during, before, or after taking a picture.

It needs to be understood that different embodiments allow different parts to be carried out in different elements. For example, the search may be carried out entirely in one user device like 250, 251 or 260, or the search may be entirely carried out in one server device 240, 241, 242 or 290, or the search may be carried out across multiple user devices 250, 251, 260 or across multiple network devices 240, 241, 242, 290, or across user devices 250, 251, 260 and network devices 240, 241, 242, 290. The search can be implemented as a software component residing on one device or distributed across several devices, as mentioned above. The search may also be a service where the user accesses the search through an interface e.g. using a browser.

Here it has been noticed that being able to search images by sound may improve the search results as audio contains a set of information related, e.g., to the context, situation, or the environment where the image was taken (sounds of nature and people). For example, let us consider a case when the user shoots pictures of buildings of different color on noisy streets in different cities. If search results are presented using image color histograms only, buildings with different color may not appear close in the search results when searching images that are similar to a building with a certain color. However, if the audio ambiance is included in the search criterion and in the data to be searched for, the buildings taken on city streets may be more likely to appear high in the search results. Global Positioning System (GPS) location can be used in the search such that pictures taken at close physical places are returned, but this does not help if the user wishes to find e.g. similar pictures from different cities. It is expected that the audio ambiance is quite city-like in different cities and improves in these cases. Moreover, audio ambiance may have the benefit over GPS location that it may not need a satellite fix to be usable and may work also indoors and places where there is no direct visibility to the sky.

Audio attributes may be utilized in searching for still images. When a still image is taken, a short audio clip is recorded. The audio clip is analyzed, and the analysis results are stored along with other image metadata. The audio itself needs not necessarily be stored. The audio analysis results stored with the images may facilitate searching images by audio similarity: “Find images which I took in an environment that sounded the same, or which have similar sound producing objects”. The user may perform query-by-image such that, in addition to comparing the features and similarity of the image contents, the audio features related to the given image are compared to the reference images and closest matches returned. Thus, the similarity based on audio analysis may be used to adapt the image search results. The user may also record a short sound clip, and find images that were taken in environments with similar audio ambiance.

One embodiment may be implemented in an end-to-end content sharing service such as Ovi Share or Image Space both by Nokia. In this case, audio recording and feature extraction may happen on the mobile device, and the server may perform further audio analysis, indexing of audio analysis results, and the searches based on similarity.

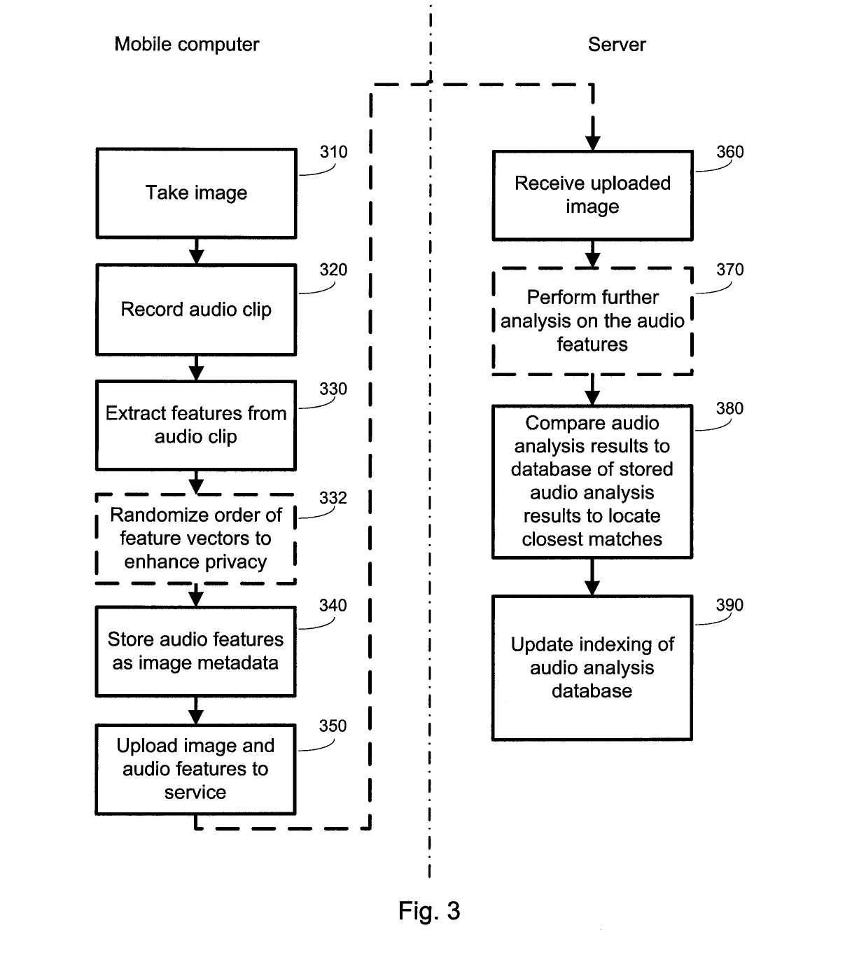

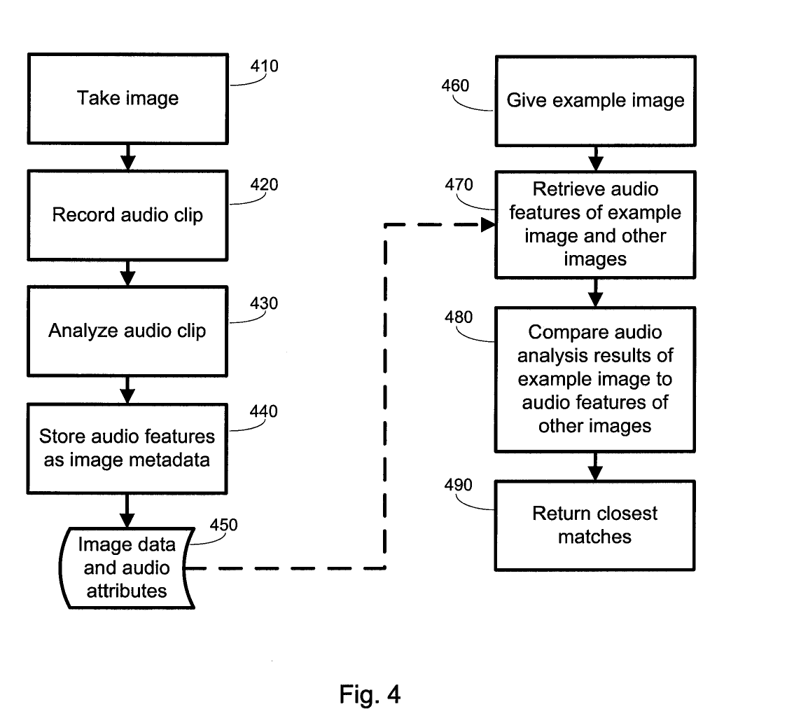

FIG. 3 presents a method according to an embodiment for image searching in an end-to-end content sharing solution such as Ovi Share or Image Space. The figure depicts the operation flow when an image is taken with the mobile device and uploaded to the service. When queries for similar images are made at the service, the operation may be similar to the one presented on the right hand side of FIG. 4. In step 310, the user may take a picture or a piece of video e.g. with the mobile phone camera. Alternatively, the picture may be taken with a standalone camera and uploaded to a computer. Yet alternatively, the standalone camera may have processing power enough for analysing images and sounds and/or the standalone camera may be connected to the mobile network or internet directly. Yet alternatively, the picture may be taken with a camera module that has processing power and network connectivity to transmit the image or image raw data to another device. In step 320, a short audio clip may be recorded; and in step 330 features may be extracted from the audio clip. The features can be e.g. mel-frequency cepstral coefficients (MFCCs) as described later. In step 332, the mobile device may perform a privacy enhancing operation to the audio features before uploading to the service. Such a method may consist of randomizing the order of the feature vectors. The purpose of the method is that speech can no longer be recognized but information characterizing ambient background noise still remains. In step 340, the extracted audio features may be stored along with the image as metadata or associated with the image data in some other way like using a hyperlink. In step 350, the image along with audio features may next be uploaded to a content sharing service such as Nokia Ovi. The following steps may be done at the server side.

When the server receives the image along with audio features in step 360, it may perform further processing to the audio features. The further processing in step 370 may mean, for example, computing the mean, covariance, and inverse covariance matrix of the MFCC features as described later to be used as model for the probability distribution of the feature vector values of the audio clip. The further analysis may also include estimating the parameters of a Gaussian Mixture Model or a Hidden Markov Model to be used as a more sophisticated model of the distribution of the feature vector values of the audio clip. The further analysis may also include running a classifier such as audio-based context recognizer, speaker recognizer, speech/music discriminator, or other analyzer to produce further meaningful information from the audio clip. The further analysis may also be done in several steps, for example such that first a speech/music discriminator is used to categorize the audio clip to portions containing speech and music. After this, the speech segments may be subjected to speech specific further analysis such as speech and speaker recognition, and music segments to music specific further analysis such as music tempo estimation, music key estimation, chord estimation, structure analysis, music transcription, musical instrument recognition, genre classification, or mood classification. The benefit of running the analyzer at the server may be that it reduces the computational load and battery consumption at the mobile device. Moreover, much more computationally intensive analysis methods may be performed than is possible in the mobile device. When the further analysis has been performed to the received features, the analysis results may be stored to a database.

To perform the search in step 380, the audio features may be compared to analysis results of previously received audio recordings. This may comprise, for example, computing a distance between the audio analysis results of the received audio clip and all or some of the audio clips already in the database. The distance may be measured, for example, with the symmetrised Kullback-Leibler divergence between the Gaussian fitted on the MFCC features of the new audio clip and the Gaussians fitted to other audio clips in the database. The Kullback-Leibler divergence measure will be described in more detail later. After the search in step 390, indexing information can be updated at the server. This is done in order to speed up queries for similar content in the future. Updating the indexing information may include, for example, storing a certain number of closest audio clips for the new audio clip. Alternatively, the server may compute and maintain clusters of similar audio clips in the server, such that each received audio clips may belong to one or more clusters. Each cluster may be represented with one or more representative audio clip features. In this case, distances from the newly received audio clip may be computed to the cluster centers and the audio clip may be assigned to the cluster corresponding to the closest cluster center distance.

Responding to online content queries may happen as described in the right hand side of FIG. 4. When queries for similar images are made, the similarity results may be adapted based on distances between the audio clips in the service. The results can be returned fast based on the indexing information. For example, if the image used as search query is already in the database, based on the indexing information the system may return a certain number of closest matches just with a single database query. If clustering information is maintained at the server, the server may first compute a distance from the audio clip of the query image to the cluster centers, and then compute distances within that cluster, avoiding the need to compute distances to all the audio clips in the system. The final query results may be determined, for example, based on a summation of a distance measure based on image similarity and audio clip similarity. In addition, other sensory information such as distance between GPS location coordinates may be combined to obtain the final ranking of query results.

A method according to an example embodiment is shown FIG. 4. The method may be implemented e.g. on a mobile terminal with a camera and audio recording capability. When a still image or a video is taken in step 410, an audio clip (e.g. 10 s for still images) may be recorded with the microphone in step 420. The audio recording may start e.g. when the user presses the launch button to begin the auto-focus feature, and end after a predetermined time. Alternatively, the audio recording may take place continuously when the camera application is active and a predetermined window of time with respect to the shooting time of the image is selected to the short audio clip to be analyzed. The image may be stored and encoded as in conventional digital cameras.

In step 430, the audio sample may be processed to extract audio attributes. The analysis may comprise extracting audio features such as mel-frequency cepstral coefficients (MFCC). Other audio features, such as MPEG-7 audio features, can be used as well. The audio attributes obtained based on the analysis may be stored as image metadata or associated with the image some other way in step 440. The metadata may reside in the same file as the image. Alternatively, the metadata may reside in a separate file from the image file and just be logically linked to the image file. That logical linking can exist also in a server into which both metadata and image file have been uploaded. Several variants exist on what information attributes may be stored. The audio attributes may be audio features, such as MFCC coefficients. The attributes may be descriptors or statistics derived from the audio features, such as mean, covariance, and inverse covariance matrices of the MFCCs. The attributes may be recognition results obtained from an audio-based context recognition system, a speech recognition system, a speech/music discriminator, speaker gender or age recognizer, or other audio object analysis system. The attributes may be associated with a weight or probability indicating how certain the recognition is. The attributes may be spectral energies at different frequency bands, and the center frequencies of the frequency bands may be evenly or logarithmically distributed. The attributes may be short-term energy measures of the audio signal. The attributes may be linear prediction coefficients (LPC) used in audio coding or parameters of a parametric audio codec or parameters of any other speech or audio codec. The attributes may be any transformation of the LPC coefficients such as reflection coefficients or line spectral frequencies. The LPC analysis may also be done on a warped frequency scale instead of the more conventional linear frequency scale. The attributes may be Perceptual Linear Prediction (PLP) coefficients. The attributes may be MPEG-7 Audio Spectrum Flatness, Spectral Crest Factor, Audio Spectrum Envelope, Audio Spectrum Centroid, Audio Spectrum Spread, Harmonic Spectral Centroid, Harmonic Spectral Deviation, Harmonic Spectral Spread, Harmonic Spectral Variation, Audio Spectrum Basis, Audio Spectrum Projection, Audio Harmonicity or Audio Fundamental Frequency or any combination of them. The attributes may be zero-crossing rate indicators of some kind. The attributes may be the crest factor, temporal centroid, or envelope amplitude modulation. The attributes may be indicative of the audio bandwidth. The attributes may be spectral roll-off features indicative of the skewness of the spectral shape of the audio signal. The attributes may be indicative of the change of the spectrum of the audio signal such as the spectral flux. The attributes may be a spectral centroid according to the formula

$${SC}_{t} = \frac{{\sum }_{k = 0}^{K} k \vert {X}_{t} ( k ) \vert}{{\sum }_{k = 0}^{K} k \vert {X}_{t} ( k ) \vert}$$

where Xₜ(k) is the kth frequency sample of the discrete Fourier transform of the ith frame and K is the index of the highest frequency sample.

The attributes may also be any combination of any of the features or some other features not mentioned here. The attributes may also be a transformed set of features obtained by applying a transformation such as Principal Component Analysis, Linear Discriminant Analysis or Independent Component Analysis to any combination of features to obtain a transformed set of features with lower dimensionality and desirable statistical properties such as uncorrelatedness or statistical independence.

The attributes may be the feature values measured in adjacent frames. To elaborate, the attributes may be e.g. a K+1 by T matrix of spectral energies, where K+1 is the number of spectral bands and T the number of analysis frames of the audio clip. The attributes may also be any statistics of the features, such as the mean value and standard deviation calculated over all the frames. The attributes may also be statistics calculated in segments of arbitrary length over the audio clip, such as mean and variance of the feature vector values in adjacent one-second segments of the audio clip.

It is noted that the analysis of the audio clip need not be done instantaneously after shooting the picture and the audio clip. Instead, the analysis of the audio clip may be done in a non-real-time fashion and can be postponed until sufficient computing resources are available or the device is being charged.

In one embodiment, resulting attributes 450 are uploaded into a dedicated content sharing service. Attributes could also be saved as tag-words. In one embodiment, a single audio clip represents several images, usually taken temporally and/or spatially close to each other. The features of the single audio clip are analyzed and associated to these several images. The features may reside in a separate file and be logically linked to the image files, or a copy of the features may be included in each of the image files.

When a user wishes to make a query in the system, he may select one of the images as an example image to the system in step 460 or give search criteria as input in some other way. The system may then retrieve the audio attributes from the example image and other images in step 470. The audio attributes of the example image are then compared to the audio attributes of the other images in the system in step 480. The images with the closest audio attributes to the example image receive higher ranking in the search results and are returned in step 490.

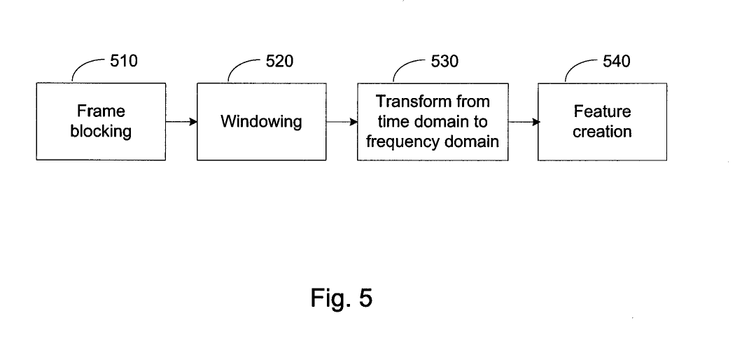

FIG. 5 shows the forming of audio features or audio attributes where at least one transform from time domain to frequency domain may be applied to the audio signal. In step 510, frames are extracted from the signal by way of frame blocking. The blocks extracted may comprise e.g. 256 or 512 samples of audio, and the subsequent blocks may be overlapping or they may be adjacent to each other according to hop-size of for example 50% and 0%, respectively. The blocks may also be non-adjacent so that only part of the audio signal is formed into features. The blocks may be e.g. 30 ms long, 50 ms long, 100 ms long or shorter or longer. In step 520, a windowing function such as the Hamming window or the Hann window is applied to the blocks to improve the behaviour of the subsequent transform. In step 530, a transform such as the Fast Fourier Transform (FFT) or Discrete Cosine Transform (DCT), or a Wavelet Transform (WT) may be applied to the windowed blocks to obtain transformed blocks. Before the transform, the blocks may be extended by zero-padding. The transformed blocks now show e.g. the frequency domain characteristics of the blocks. In step 540, the features may be created by aggregating or downsampling the transformed information from step 530. The purpose of the last step may be to create robust and reasonable-length features of the audio signal. To elaborate, the purpose of the last step may be to represent the audio signal with a reduced set of features that well characterizes the signal properties. A further requirement of the last step may be to obtain such a set of features that has certain desired statistical properties such as uncorrelatedness or statistical independence.

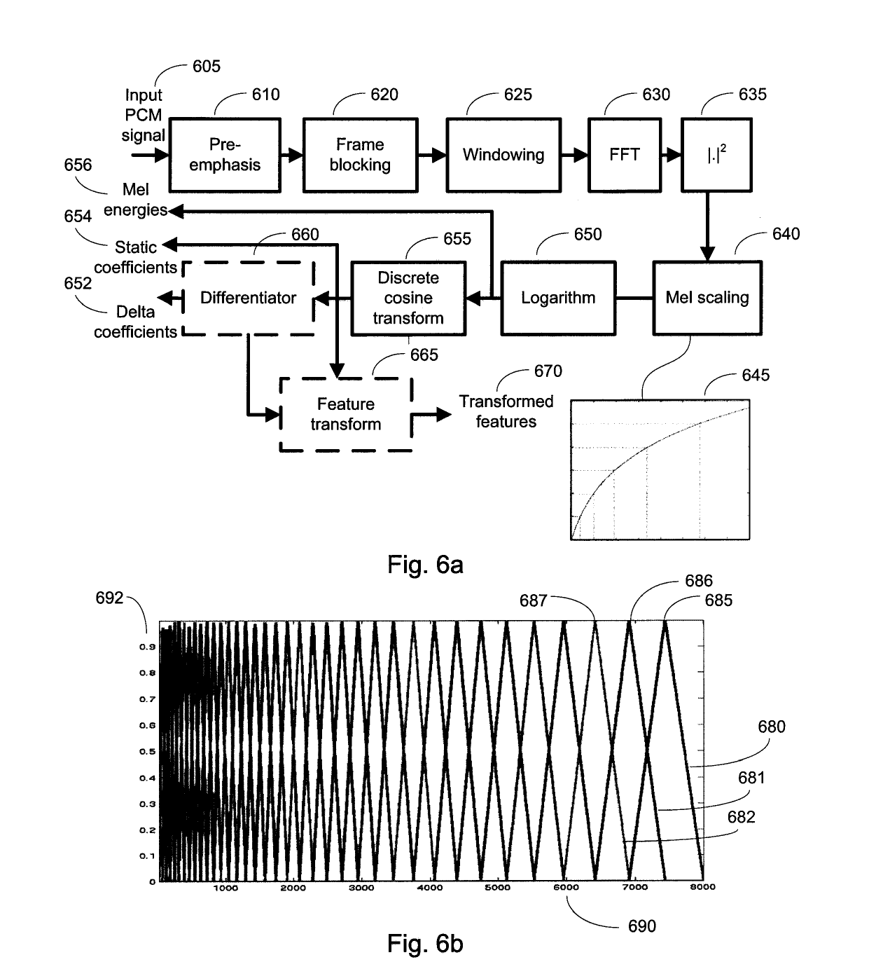

FIG. 6 shows the creation of mel-frequency cepstral coefficients (MFCCs). The input audio signal 605, e.g. in pulse code modulated form, is fed to the pre-emphasis block 610. The pre-emphasis block 610 may be applied if it is expected that in most cases the audio contains speech and the further analysis is likely to comprise speech or speaker recognition, or if the further analysis is likely to comprise the computation of Linear Prediction coefficients. If it is expected that the audio in most cases is e.g. ambient sounds or music it may be preferred to omit the pre-emphasis step. The frame blocking 620 and windowing 625 operate in a similar manner as explained above for steps 510 and 520. In step 630, a Fast Fourier Transform is applied to the windowed signal. In step 635, the FFT magnitude is squared to obtain the power spectrum of the signal. The squaring may also be omitted, and the magnitude spectrum used instead of the power spectrum in the further calculations. This spectrum can then be scaled by sampling the individual dense frequency bins into larger bins each spanning a wider frequency range. This may be done e.g. by computing a spectral energy at each mel-frequency filterbank channel by summing the power spectrum bins belonging to that channel weighted by the mel-scale frequency response. The produced mel-filterbank energies may be denoted by \tilde{m}ⱼ, j=1, . . . ,N, where N is the number of bandpass mel-filters. The frequency ranges created in step 640 may be according to a so-called mel-frequency scaling shown by 645, which resembles the properties of the human auditory system which has better frequency resolution at lower frequencies and lower frequency resolution at higher frequencies. The mel-frequency scaling may be done by setting the channel center frequencies equidistantly on the mel-frequency scale, given by the formula

$$Mel ( f ) = 2595 {log}_{10} ( 1 + \frac{f}{700} ) ,$$

where f is the frequency in Hertz.

An example mel-scale filterbank is given in FIG. 6b. In FIG. 6b, 36 triangular-shaped bandpass filters are depicted whose center frequencies 685, 686, 687 and others not numbered may be evenly spaced on the perceptually motivated mel-frequency scale. The filters 680, 681, 682 and others not numbered may span the frequencies 690 from 30 hz to 8000 Hz. For sake of example, the filter heights 692 have been scaled to unity. Variations may be made in the mel-filterbank, such as spanning the band center frequencies linearly below 1000 Hz, scaling the filters such that they will have unit area instead of unity height, varying the number of mel-frequency bands, or changing the range of frequencies the mel-filters span.

In FIG. 6a in step 650, a logarithm, e.g. a logarithm of base 10, may be taken from the mel-scaled filterbank energies \tilde{m}ⱼ producing the log filterbank energies mⱼ, and then a Discrete Cosine Transform 655 may be applied to the vector of log filterbank energies mⱼ to obtain the MFCCs 654 according to

$${c}_{mel} ( i ) = {\sum }_{j = 1}^{N} {m}_{j} cos ( \frac{π \cdot i}{N} ( j - \frac{1}{2} ) )$$

where N is the number of mel-scale bandpass filters. i=0, . . . ,I and I is the number of cepstral coefficients. In an exemplary embodiment, I=13. It is also possible to obtain the mel energies 656 from the output of the logarithm function. The sequence of static MFCCs can be differentiated 660 to obtain delta coefficients 652. It is also possible to apply a transform 665 to the features to obtain transformed features 670 for example to reduce the dimensionality or to obtain more feasible statistical properties like uncorrelatedness, or both. As a result, the audio features may be for example 13 mel-frequency cepstral coefficients per audio frame, 13 differentiated MFCCs per audio frame, 13 second degree differentiated MFCCs per audio frame, and an energy of the frame.

In one embodiment, different analysis is applied to different temporal segments of the recorded audio clip. For example, audio recorded before and during shooting of the picture may be used for analyzing the background audio ambiance, and audio recorded after shooting the picture for recognizing keyword tags uttered by the user. In another embodiment, there may be two or more audio recordings: one done when the picture is taken and another later on in a more convenient time. For example, the user might add additional tags by speaking when browsing the images for the first time.

In one embodiment of the invention, the search results may be ranked according to audio similarity, so that images with the most similar audio attributes are returned first.

In some embodiments of the invention, the similarity obtained based on the audio analysis is combined with a second analysis based on image content. For example, the images may be analyzed e.g. for colour histograms and a weighted sum of the similarities/distances of the audio attributes and image features may be calculated. For example, such combined audio and image comparison may be applied in steps 380 and 480. For example, a combined distance may be calculated as

D(s,i)=w₁·(d(s,i)−m₁)/s₁+w₂·(d₂(s,i)−m₂)/s₂,

where w₁ is a weight between 0 and 1 for the scaled distance d(s,i) between audio features, and m₁ and s₁ are the mean and standard deviation of the distance d. The scaled distance d between audio features is described in more detail below. d₂(s,i) is the distance between the image features of images s and i, such as the Euclidean distance between their color histograms, and m₂ and s₂ are the mean and standard deviation of the distance, and w₂ its weight. To compute the mean and standard deviation, a database of image features may be collected and the various distances d(s,i) and d₂(s,i) computed between the images in the database. The means m₁, m₂ and standard deviations s₁, s₂ may then be estimated from the distance values between the items in the database. The weights may be set to adjust the desired contribution of the different distances. For example, the weight w₁ for the audio feature distance d may be increased and the weight w₂ for the image features lowered if it is desired that the audio distance weighs more in the combined distance.

In some embodiments of the invention, the similarity obtained based on the audio analysis may be combined with other pieces of similarity obtained from image metadata, such as the same or similar textual tags, similar time of year and time of day and location of shooting a picture, and similar camera settings such as exposure time and focus details, as well as potentially a second analysis based on image content.

In one embodiment of the invention, a generic audio similarity/distance measure may be used to find images with similar audio background. The distance calculation between audio clips may be done e.g. with the symmetrised Kullback-Leibler (KL) divergence, which takes as parameters the mean, covariance, and inverse covariance of the MFCCs of the audio clips. The symmetrised KL divergence may be expressed as

$$KLS ( s , i ) = \frac{1}{2} [ \begin{matrix}Tr ( {\sum }_{i}^{- 1} {\sum }_{s}^{ } + {\sum }_{s}^{- 1} {\sum }_{i}^{ } ) - 2 D + \\ {( {μ}_{s} - {μ}_{i} )}^{T} ( {\sum }_{i}^{- 1} + {\sum }_{s}^{- 1} ) ( {μ}_{s} - {μ}_{i} )\end{matrix} ] .$$

where Tr denotes the trace and where the mean, covariance and inverse covariance of the MFCCs of the example image are denoted by μₛ, Σₛ, and Σₛ⁻¹, respectively, the parameters for the other image are denoted with the subscript i, and d by 1 is the dimension of the feature vector. The mean vectors are also of dimension d by 1, and the covariance matrices and their inverses have dimensionality d by d. The symmetrized KL divergence may be scaled to improve its behavior when combining with other information, such as distances based on image color histograms or distances based on other audio features. The scaled distance d(s,i) may be computed as

d(s,i)=−exp(−γ·KLS(s,i)),

where γ is a factor controlling the properties of the scaling and may be experimentally determined. The value may be e.g. γ=1/450 but other values may be used as well. The similarity/distance measure may also be based on Euclidean distance, correlation distance, cosine angle, Bhattacharyya distance, the Bayesian information criterion, or on L1 distance (taxi driver's distance), and the features may be time-aligned for comparison or they may not be time-aligned for comparison. The similarity measure may be a Mahalanobis distance taking into account feature covariance.

The benefit of storing audio features for the image may be that the audio samples do not need to be stored, which saves memory. When a compact set of audio related features is stored, the comparison may be made with images with any audio on the background using a generic distance between the audio features.

In another embodiment of the invention, a speech recognizer is applied on the audio clip to extract tags uttered by the user to be associated to the image. The tags may be spoken one at a time, with a short pause in between them. The speech recognizer may then recognize spoken tags from the audio clip, which has been converted into a feature representation (MFCCs for example). The clip may be first segmented segments containing a single tag each using a Voice Activity Detector (VAD). Then, for each segment, speech recognition may be performed such that a single tag is assumed as output. The recognition may be done based on a vocabulary of tags and acoustic models (such as Hidden Markov Models) for each of the tags, as follows:
1) First, an acoustic model for each tag in the vocabulary may be built.
2) Then, for each segment, the acoustic likelihood of each of the models producing the feature representation of the current tag segment may be calculated.
3) The tag, whose model gave the best likelihood, may be chosen as the recognition output.
4) Repeat 2) and 3) until all segments have been recognized

The recognition may be performed on the same audio clip as is used for audio similarity measurement, or a separate clip recorded by the user at a later, and perhaps more convenient time. The recognition may be done entirely on the phone or such that the audio clip or the feature representation is sent to a server backend which performs the recognition and then sends the recognized tags back to the phone. Recognition results may also be uploaded into a multimedia content sharing service.

In another embodiment of the invention, moving sound objects (e.g. number of objects, speed, direction) may be analyzed from the audio.

In another embodiment of the invention, the direction of the audio objects may be used to affect the weights associated with the tags and/or to create different tag types. For example, if the directional audio information indicates that the sound producing object is in the same direction where the camera points at (determined by the compass) it may be likely that the object is visible in the image as well. Thus, the likelihood of the object/tag is increased. If the sound producing object is located in some other direction, it may be likely not included in the image but is tagged as a background sound. In another embodiment, different tag types may be added for objects in the imaged direction and objects in other direction. For example, there might be tags

<car><background><0.3>

<car><foreground><0.4>

indicating that a car is recognized in the foreground with probability 0.4 and in the background with probability 0.3. These two types of information may be included in the image searches, e.g. for facilitating searching images of cars, or images with car sounds in the background.

In addition, the parameterization of the audio scene captured with more than one microphone may reveal the number of audio sources in the image or in the area the picture was taken outside the direction camera was pointing.

The captured audio may be analyzed with binaural cue coding (BCC) parameterization determining the inter channel level and time differences at sub-band domain. The multi channel signal may be first analyzed e.g. with short term Fourier transform (STFT) splitting the signal into time-frequency slots. Now, analyzing the level and time differences in each time-frequency slot as follows:

$$Δ {L}_{n} = 10 {log}_{10} ( \frac{{S}_{n}^{L} * {S}_{n}^{L}}{{S}_{n}^{R} * {S}_{n}^{R}} )$$

$${ϕ}_{n} = ∠ ( {S}_{n}^{L} * {S}_{n}^{R} )$$

where Sₙ^{L} and Sₙ^{R} are the spectral coefficient vectors of left and right (binaural) signal for sub-band n of the given analysis frame, respectively, and * denotes complex conjugate. There may be 10 or 20 or 30 sub-bands or more or less. Operation ∠ corresponds to atan 2 function determining the phase difference between two complex values. The phase difference may naturally correspond to the time difference between left and right channels.

The level and time differences may be mapped to a direction of arrival of the corresponding audio source using panning laws. When the level and time difference are close to zero, the sound source at that frequency band may be located directly in between the microphones. If the level difference is positive and it appears that the right signal is delayed compared to the left, the equations above may indicate that the signal is most likely coming from the left side. The higher the absolute value of the level and time difference is, the further away from the center the sound source may be.

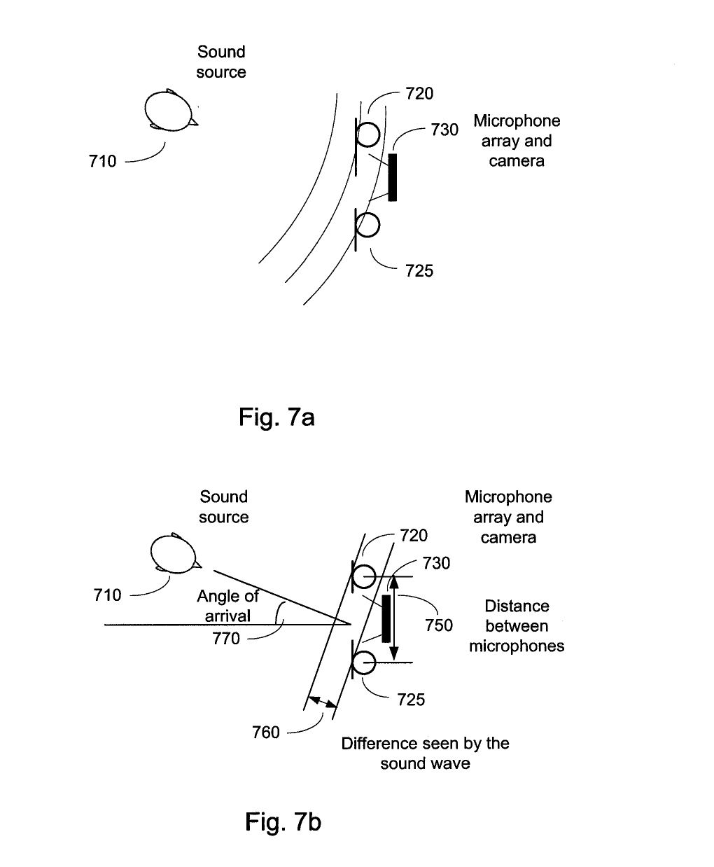

FIGS. 7a and 7b show the setup for detecting sound direction in relation to the microphone array and the camera for obtaining an image. The sound source 710 emits sound waves that propagate towards the microphones 720 and 725 at the speed c. The sound waves arrive to microphones at different times depending on the location of the sound source. The camera 730 may be part of the same device as the microphones 720 and 725. For example, the camera and the microphones may be parts of a mobile computing device, a mobile phone etc. In FIG. 7b, the distance |x₁−x₂| 750 between microphones is indicated, as well as the distance 760 seen by the sound wave. The distance 760 seen by the sound wave depends on the angle of arrival 770 and the distance 750 between the microphones. This dependency can be used to derive the angle of arrival 770 from the distance 760 seen by the sound wave and the distance 750 between microphones.

The time difference may be mapped to the direction of arrival e.g. using the equation

τₘ=(|xₘ−xᵢ|sin(φ))/c

where xᵢ is the location of microphone i, and c is the speed of sound. The angle of arrival is then

φ=sin⁻¹(τₘc/xₘ−xᵢ|).

The level difference may be mapped to direction of arrival using e.g. sine law

$$\frac{sin ( φ )}{sin ( {φ}_{0} )} = \frac{{g}_{1} - {g}_{2}}{{g}_{1} + {g}_{2}}$$

where φ is the direction of arrival, φ₀ is the angle between the axis perpendicular to the microphone pair and the microphone in the array. g₁ and g₂ are gains for channel 1 and 2, respectively, indicative of the signal energy. When the level difference is known, and we know that

$$\sqrt{{\sum }_{i = 1}^{2} {g}_{i}^{2}} = 1 ,$$

gains may be determined for calculating the angle of arrival.

The correlation of the time frequency slot determined as

$${Φ}_{n} = \frac{{S}_{n}^{L} * {S}_{n}^{R}}{\sqrt{( {S}_{n}^{L} * {S}_{n}^{L} ) ( {S}_{n}^{R} * {S}_{n}^{R} )}}$$

may be used to determine the reliability of the parameter estimation. Correlation value close to unity represents reliable analysis. On the other hand, low correlation value may indicate a diffuse sound field without explicit sound sources. In this case the analysis could concentrate on ambience and background noise characteristics.

The analysis tool may collect the level and time difference data converted to direction of arrival information and their distribution. Most likely the distributions (with high correlation value) concentrate around the sound sources in the audio image and reveal the sources. Even the number of different sources may be determined. In addition, when determining the evolution of the distribution in time, the average motion and the speed of the sound source may be determined. In addition or instead of the direction of arrival information, Doppler effect information may be used in determining the changes in speed of a moving object.

Alternatively, beamforming algorithms may be applied to determine the direction of strong sound sources. When the direction is known the beamformer could be further used to extract the source, and cancel out the noise around it, for additional analysis. The beamforming algorithm may be run several times to extract all the probable sources in the audio image. In addition to or alternatively to beamforming, audio sources and/or their directions may be detected by means of a signal-space projection method (SSP) or by means of any type of a principal component analysis method.

In one embodiment of the invention, both the image and audio are analyzed. For example, objects such as speakers or cars may be recognized from the image using image analysis methods and from the audio using speaker recognition methods. Each recognition result obtained from the audio analyzer and image analyzer may be associated with a probability value. The probability values for different tags obtained from image and audio analysis are combined, and the probability is increased if both analyzers return a high probability for related object types. For example, if the image analysis results indicate a high probability of a car being present in the image, and an audio-based context recognizer indicates a high probability of being in a street, the probability for both these tags may be increased.

The input for the similarity query need not be restricted to an image with audio similarity information. Instead of giving an example image, the user may also record a short sound clip and search for images taken in places with similar background ambiance. This may be useful if the user wishes to retrieve images taken on a noisy street, for example. In addition to an example image, the user may give keywords for the search that further narrow down the desired search results. The keywords may be compared to tags derived to describe the images.

The item being recorded, the input for the similarity query, and the searched items need not be restricted to images with audio similarity information, but any combination of them can also be video clips. If a video clip is recorded, the associated audio clip is not recorded separately. The audio attributes may be analyzed, the input query may be given, and the search results returned for the entire video clip or for segments in time. The search results may contain images, segments of video clips, and entire video clips.

In some embodiments of the invention, a user takes a photo in step 310 or 410, video is recorded similarly to audio in step 320 or 420, video features are extracted from the video clip in step 330 or 430, and the video features are stored as image metadata in step 340 or 440. Further, video features are additionally uploaded to a service in step 350 or stored in step 450. Video features are further used in comparing images in 380 or 480, potentially in combination with image features, audio features, and other image metadata as described in other embodiments.

The invention can be implemented into an online service, such as the Nokia Image Space or Nokia OVI/Share. The Image Space is a service for sharing still pictures the users have shot in a certain place. It can also store and share audio files associated with a place. The presented invention can be used to search for similar images in the service, or to find places with similar audio ambience.

In general, the processing blocks of FIG. 4 need not happen in a single device, but the processing can be distributed to several devices. As stated above, the recording of the image+audio clip and the analysis of the audio clip can take place in separate devices. The images being searched can reside in separate devices. The JPSearch architecture or the MPEG Query Format architecture may be used in realizing the separation of the functional blocks into multiple devices. The JPSearch format or MPEG Query Format may be extended to cover the invention, i.e., that images with associated audio features are enabled as query inputs and query outputs can contain information on how well the associated audio features are met in a particular search hit.

The various embodiments of the invention may be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1.-30. (canceled)

31. A method, comprising:
electronically generating image data,
electronically generating audio features, the audio features having been created from audio data by feature analysis,
electronically associating the audio features with the image data, and
electronically carrying out a search from the image data using the audio features to form image search results.

32. A method according to claim 31, further comprising:
forming audio data in memory and
analyzing the audio data to create audio features.

33. A method according to claim 31, further comprising:
receiving a first criterion for performing a search among the image data,
receiving a second criterion for performing a search among the audio features, and
carrying out the search using the first criterion and the second criterion to form image search results.

34. A method according to claim 31, further comprising:
carrying out the search by comparing the audio features of the audio data among which the search is
carried out with a second set of audio features associated with image data defined by a user.

35. A method according to claim 31, wherein the audio features have been created by applying at least one transform from time domain to frequency domain to the audio data.

36. An apparatus comprising a processor, memory including computer program code, the memory and the computer program code configured to, with the processor, cause the apparatus to perform at least the following:
form image data in the memory of the apparatus,
form audio features in the memory of the apparatus, the audio features having been created from audio data by feature analysis,
associate the audio features with the image data, and
carry out a search from the image data using the audio features to form image search results.

37. An apparatus of claim 36, wherein the apparatus is further caused to:
form audio data in the memory of the apparatus, and
analyze the audio data to create audio features.

38. An apparatus of claim 36, wherein the apparatus is further caused to:
receive a first criterion for performing a search among the image data,
receive a second criterion for performing a search among the audio features, and
early out the search using the first criterion and the second criterion to form image search results.

39. An apparatus of claim 36, wherein the apparatus is further caused to:
carry out the search by comparing the audio features of the audio data among which the search is carried out with a second set of audio features associated with image data defined by a user.

40. An apparatus according to claim 36, wherein the audio features have been created by applying at least one transform from time domain to frequency domain to the audio data.

41. An apparatus of claim 36, wherein the apparatus is further caused to:
create the audio features by extracting mel-frequency cepstral coefficients from the audio data.

42. An apparatus according to claim 36, wherein the audio features are indicative of a direction of a source of an audio signal in the audio data in relation to a direction of an image signal in the image data.

43. An apparatus of claim 36, wherein the apparatus is further caused to:
analyze the audio data to create audio features by applying at least one of audio-based context recognition, speech recognition, speaker recognition, speech/music discrimination, determining the number of audio objects, determining a direction of audio objects, and speaker gender determination.

44. A method, comprising:
electronically generating a first search criterion for carrying out a search among image data,
electronically generating a second search criterion for carrying out a search among audio features created from audio data associated with the image data, and
electronically carrying out a search to form image search results by using the first search criterion and the second search criterion.

45. A method according to claim 44, further comprising:
forming the second search criterion by defining a set of audio features associated with the image data to be used in the search.

46. A method according to claim 44, further comprising:
capturing data to form at least a part of the image data,
capturing data to form at least part of the audio data, and
associating the at least part of the audio data with the at least part of the image data.

47. A method according to claim 46, further comprising:
creating at least part of the audio features by applying at least one transform from time domain to frequency domain to the audio data.

48. An apparatus comprising a processor, memory including computer program code, the memory and the computer program code configured to, with the processor, cause the apparatus to perform at least the following:
form a first search criterion for carrying out a search among image data,
form a second search criterion for carrying out a search among audio features created from audio data associated with the image data, and
early out a search to form image search results by using the first search criterion and the second search criterion.

49. A computer program product including one or more sequences of one or more instructions which, when executed by one or more processors, cause an apparatus to at least perform the following:
generate image data,
generate audio features, the audio features having been created from audio data by feature analysis, associate the audio features with the image data, and
carry out a search from the image data using the audio features to form image search results.

50. A computer program product including one or more sequences of one or more instructions which, when executed by one or more processors, cause an apparatus to at least perform the following:
generate a first search criterion for carrying out a search among image data,
generate a second search criterion for carrying out a search among audio features created from audio data associated with the image data, and
carry out a search to form image search results by using the first search criterion and the second search criterion.
